(19) United States
(12) Patent Application Publication
(10) Pub. No.: US 2009/0256910 A1
(43) Pub. Date: Oct. 15, 2009

(54) Camera System to detect, monitor and report low visibility

(76) Inventor: Ram Ganeshan, Sugar Land, TX (US)

Correspondence Address: Ram Ganeshan, 105 N.Hall Drive, Sugar Land, TX, 77478, US

(21) Appl. No.: 11/621,113

(22) Filed: Jan. 8, 2007

Related U.S. Application Data
(60) Provisional application No. 60/762,310, filed on Jan. 27, 2006.

(51) Int. Cl. H04N 7/18; G08G 1/09

(52) U.S. Cl. 348/148; 340/905; 348/E07.085

(57) ABSTRACT

The invention comprises of a method and a system to detect, monitor and report hazardous conditions of low visibility on roadways and waterways occurring due to fog or snow or rain or dust or smoke. A special vision camera installed on a post on the road or the waterway continuously views a set of lights installed on another post at a distance a few hundred feet away. The system software is used to set up a frame around the captured image. A value is assigned to the intensity of the light in the image under normal conditions of visibility. A tolerance range is set up around that assigned value. If the intensity value goes out of the set tolerance range due to low visibility conditions in the space between the camera and the target light(s), the software initiates an alarm state. This digital output is translated into an appropriate emergency message to be flashed on the electronic signboards on the roads or waterways.

### CROSS REFERENCE TO RELATED APPLICATION

U.S. Pat. No. 6,278,374 B1

USPTO's Number for the provisional application of this patent: 60/762,310

Provisional Application filing date: Jan. 27, 2006

### FEDERALLY SPONSORED RESEARCH

Not applicable

### SEQUENCE LISTING OF PROGRAM

not applicable

### BACKGROUND OF THE INVENTION

Thousands of lives are lost, thousands are seriously injured and billions of dollars are paid out in collateral damages every year in the USA due to automobile accidents on the roads due to low visibility caused by fog or snow storm, heavy rains, smoke and dust storms.

The invention describes an intelligent camera system that will monitor selected zones of the roads continuously for low visibility conditions and alert the motorists of the hazardous conditions well in advance.

### Comparison of Invented Technology With Available Technology:

Presently available other technology: The equipment available presently in the market place for measuring low visibility on the roads is called forward scatter visibility meter. These instruments operate within a short distance. To detect the occurrence of fog over several hundred feet, several such meters will be required, making it considerably more expensive than the camera system presented in this invention application. In addition, the forward scatter visibility meters are sophisticated scientific instruments requiring frequent calibration and maintenance. The camera system presented here, on the other hand, measures visibility directly, emulating the human eye. All the key equipment components are of solid-state electronics. There will be very little calibration and maintenance. Digital vision camera technology and digital image and data transfer technologies are making big improvements continuously.

### SUMMARY

The present invention relates to a vision camera system to detect low visibility conditions. A special vision camera with image processing software is used to view a fixed object (e.g., lights) at a distance continuously. The software in the camera and the system is programmed to process the different parameters of the images of the object. The parameters could be e.g., the intensity of the lights, the shape of the lights, the number of lights etc. When fog or snow or rain or smoke or dust lower the visibility of the images of the object (in this example, lights) to the camera, the camera recognizes the changes and reports the results to the control room and/or the Emergency Messaging Signs on the road to reduce the speed etc. Thus accidents are averted.

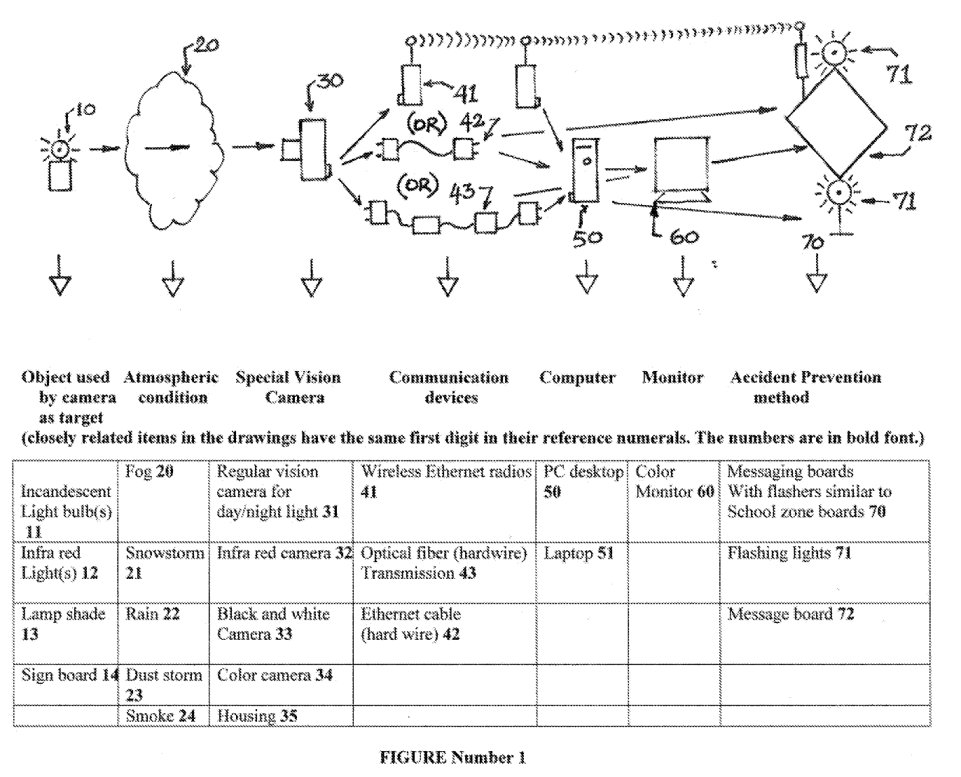

FIG. 1 shows the principle of the invention.

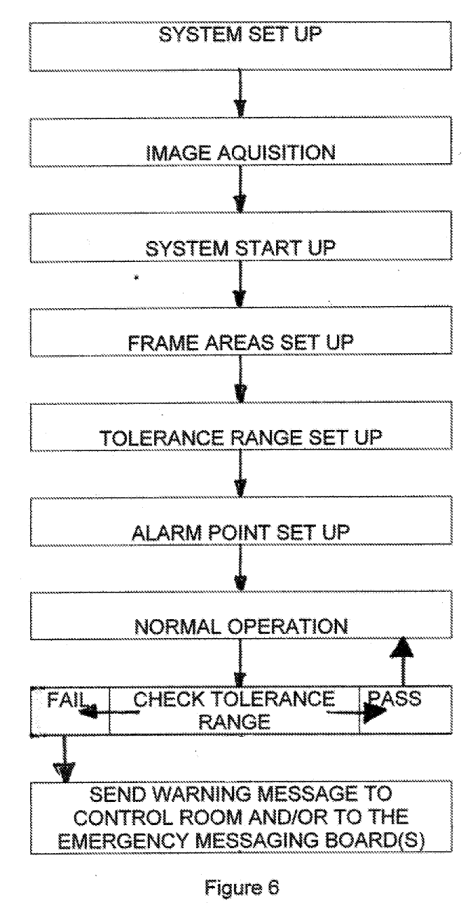

FIG. 6 shows the logic diagram of the system set up.

### EMBODIMENTS OF THE INVENTION

### 1. Camera, Lights, Wireless Ethernet Radios (WER), Flashing Lights on Emergency Messaging Board (EMB)

A preferred embodiment of the present invention provides a method for monitoring the low visibility on the road by using a vision camera, a light source, a set of wireless Ethernet radios and an Emergency Messaging Signboard with flashing lights.

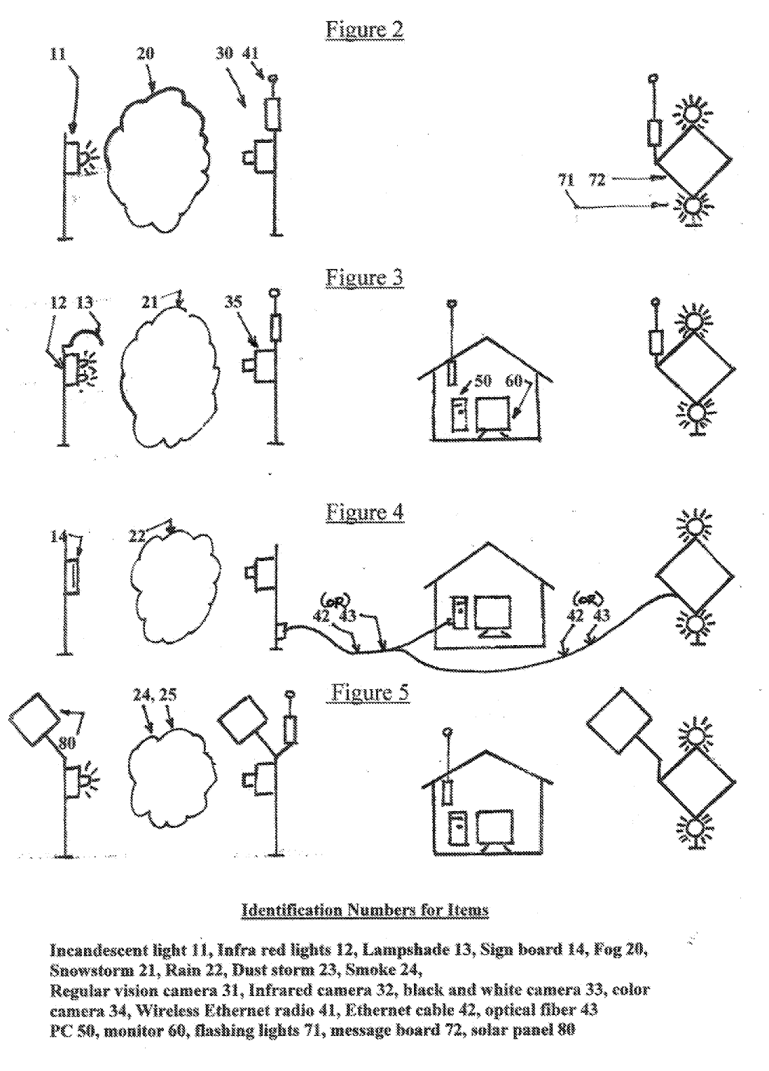

See FIG. 2.

The camera is installed in a weatherproof and climate controlled housing, mounted on a pole. The centerline of lens will be at about 15 feet height. The housing will also have a wireless Ethernet radio transmitter in it connected to the camera. It will transmit images and digital inspection results.

A light or a set of lights (in this example, four in number) is mounted on a panel (for this example, on the 4 corners of a square, 2 feet×2 feet). The panel is installed on a pole so that the center of the square is at the same elevation as the lens and the camera is viewing the 4 lights. The lights could be of infra-red type, if necessary. This pole could be at a suitable distance of 200 to 1000 feet. The camera lens will be selected for each specific distance for each custom application.

The two poles with the camera and the lights are installed on the same side of the roadway, in a stretch of the road that experiences low visibility conditions frequently. The road transportation authorities will have input in determining where to locate them.

A few miles up that road and down that road, Emergency Messaging Boards (or EMB) with flashing lights will be installed so that the motorists in both directions of traffic on that road can be alerted when low visibility situations occur. Several types of such messaging systems can be seen on US roads. Examples are: Flashers indicating “School Zone” or “Ice on Bridge” etc. The receiver radio attached to them will receive the digital data from the transmitter radio of the camera system and switch the emergency flashlights on during low visibility situations.

### 2. Camera, Lights, Wireless Ethernet Radios(WER), Computer, Monitor, EMB

Another preferred embodiment of the present invention provides a method for monitoring low visibility on the road by using a vision camera, a set of infra red or other lights, a set of wireless Ethernet radios, a computer in a control room and Emergency Messaging Signboard(s) with flashing lights.

See FIG. 3.

In this embodiment, the radio transmits the images and the data to a radio attached to a computer (could be a PC or a Laptop, as examples) in a control room. Live images of the lights and the inspection data are continuously displayed on the monitor. The computer sends signals that initiate the emergency flashlights on the EMB during low visibility situations. The logic in the computer can do other functions also such as closure of gates on the road etc. It can send live images and data throughout the department of transportation (DOT) network to alert other offices of the city or county. PCs in other areas of the DOT can access the images using the IP address of the camera.

### 3. Camera, Lights, Optical Fiber Network or Ethernet Cable, EMB

Yet another preferred embodiment of the present invention provides a method for monitoring low visibility on the road by using a vision camera, a set of IR or other lights, a fiber optic network or hardwire Ethernet cable connection to the computer or EMB, as in previous embodiments.

See FIG. 4 showing both options (fiber optic network and hardwire Ethernet cable)

The image and data transfer between the camera and the computer and/or EMB are achieved by well established technologies of optical fiber network or by direct Ethernet cables.

### 4. Camera, Lights, WER or OF or EC, Computer, EMBs and Solar Power Panels

Yet another embodiment of this invention provides for a complete system to monitor low visibility on the road by using a vision camera, a set of lights, WERs or OFs or ECs, computer, EMBs. The addition in this embodiment is that it will use solar panels to generate the power needed to operate the camera, the radios, or the OF network, the IR lights and the EMB flashing lights.

See FIG. 5.

The solar panels will be mounted on each post separately to power the components independently. This embodiment will enable the “low visibility alert station” to operate independently without requiring power hook up from the transportation authorities.

Addition of solar power panels to operate the components shall be considered as an obvious extension to all other embodiments described in this patent application.

Other features and advantages, of the present invention will be made clear to those skilled in the art by the following detailed description of the preferred embodiments constructed in accordance with the teachings of the present invention.

### BRIEF DESCRIPTION OF THE DRAWINGS

Closely related figures in the drawings have the same first digit in their reference numerals. The numbers are in bold font.

1. Object 10 is used as a target for the camera. This could be incandescent light or lights 11 or infra red light(s) 12, or the lampshade of the light 13 or a sign board 14, or any other object which will be increasingly difficult to distinguish as the visibility decreases.

2. The atmospheric condition causing low visibility is shown as a cloud on the drawings. This could be fog 20, snow 21, rain 22, dust 23, or smoke 24.

3. The special vision camera 30. The camera could be a regular black and white vision camera for day and night vision 31, or infrared camera 32, or color camera 33. The lens and filter 34 will be selected for each specific case according to distance, size of object, day/night vision or infrared vision etc. The weather proof housing 35 will have a thermostat and a fan to regulate the temperature in all climates through the year.

4. There are several established communication technologies available in the marketplace for transmitting the digital images and the digital data between the camera 30, the computer 50 and the electronic messaging boards 70. Wireless Ethernet radios 41, optical fiber network 42, hard wire Ethernet cable 43 are some of such communication technologies.

5. The computer 50 could be a desktop type or a laptop.

6. The monitor 60 shows the images and the digital results.

7. The electronic or electric messaging board 70 receives the data about the hazardous road conditions from either the camera 30 or the computer 50 and flashes the warning message on the board. The flashing lights 71 and the message board 70 are commercially available pieces of equipment.

8. Individual solar power supply systems 80 mounted on the posts for the light source 10, the camera 30, the Emergency Messaging Boards 70, etc supply power to the equipment in areas where conventional power supply is difficult to access.

### DETAILED DESCRIPTION

The FIGS. 1 to 6 describe the invention well.

### Camera Monitors Low Visibility on the Road:

An intelligent camera 30 with embedded image processing software is used to view a stationery object or objects 10 at a distance. The object or objects could be a signboard, a lamppost, a set of lights or a combination of such items. Various parameters of the object(s) such as a) the intensity of the light(s), b) the number of light(s), c) the shape of the signboard, d) the message on it, e) the sharpness and shape of the objects etc or any combination of such parameters can be programmed into the software for the camera system to inspect and process the images.

Low visibility on the road due to fog 20, or snowstorm 21, or rain 22, dust 23, or smoke 24 will alter the images seen by the camera; the objects will appear dim or non-existent, the shape and contour lines less sharp, unclear etc. A tolerance range will be programmed into the software. When low visibility occurs, the system will detect the various parameters that are outside the tolerance range and initiate an alarm state that is then translated into a emergency warning message on the flashing signs 71, 72 on the road. The motorists are instructed to lower driving speeds or to take alternate routes. The software has capabilities to set different tolerance ranges also. This will facilitate the system to determine the different degrees of the low visibility due to the changes in the parameters e.g., 75% of original intensity, 50%, 25%, etc. The emergency warning message signs on the road can thus tell the motorists of “very dense fog”, “dense fog” and “mild fog” conditions and appropriately specified safe driving speed limits.

### Camera Reports Low Visibility to Authorities:

The live images captured by the camera, its analysis and/or the inspection results are then sent to one or more of the following locations.
A computer 50 in the control room of the department of transportation can receive the images as well as the inspection data (dense fog, very dense fog etc).
An Emergency Messaging Signboard 72 on the road, a few miles ahead of the low visibility zone, can receive the inspection data and switch on the Low Visibility Warning Flashers 71.
   Communication Methods Between Camera and Control Room and/or Emergency Flashers on the Signboard on the Road

There are numerous well-established technologies available to transmit the images and the digital inspection data from the camera to the control room or to the Emergency flashers on the road.
Powerful wireless Ethernet radios 41
Optical fiber cable network 43
Hardwire Ethernet cable 42

### Alerting Motorists of Low Visibility Zone Ahead:

Road management authorities have several established methods to alert motorists.

Warning messages on boards with flashers 71, 72

Road closure signs

Gates lowered as road barriers

### Details of Equipment Used in the Invention:

### Vision Camera:

The invention uses a special vision camera. It could be a black and white camera or a color camera. It is commonly called as a machine vision camera in the industry. Such cameras are used in thousands of different applications in various industries

To inspect objects for quality control

To sort objects

To read barcodes on labels

Etc

Such cameras are available with varying capabilities (black and white, color, infra red, ultra violet, mega pixels, and consequently in various price ranges).

Some cameras can analyze a few parameters in the images they capture, some other cameras a lot more.

A camera capable of analyzing one or more of the following parameters is used for this invention of monitoring low visibility on the road due to fog or snowstorm or heavy rain or smoke or dust.

Variation in the intensity of the light reaching the camera

Count the number of objects (e.g., lights) in the image captured

Blob analysis (pixel counting)

Sharpness of the image

Shape of the image

### Object(s) to be Viewed by the Camera:

Infra red lights are invisible to the motorists. They will therefore not distract the attention of motorists from the road. Also IR lights have a long life. More than one light will be installed to insure redundancy.

The LED infra red lights operate on 12V DC and consume very little power; less than 5W. If a standard 110 V supply is not easily available, a solar panel can supply that power.

The IR lights can be housed in a weatherproof enclosure to prevent rain and snow from interfering with the view.

A lamppost or a signboard along the road can also be used as additional objects to be viewed by the camera. This will involve additional (one-time) programming of the software in the camera to make adjustments for the daytime and nighttime light conditions.

Such objects to be viewed can be placed at distances between a few hundred feet to a thousand feet.

### Lens:

Depending upon the object(s) selected for each specific application and its distance from the camera, a lens will be chosen with the correct focal length, zoom, wide angle etc.

If the object(s) to be viewed are infra red light(s), then an adequate IR filter will be fitted to the lens.

### Power for the Camera:

The cameras operate on 12 or 24V DC. Their power requirement is low; in the 5 to 10 W range. A conversion adapter connected to a 110V or 220V AC power source or a solar panel can supply this power. Solar panels make the camera independent.

### Weather Proofing for the Camera:

The camera is small enough to be installed in housings to suit any installation environment, including areas where salt and/or water can be an issue for other systems. In installation areas where surface debris can be a problem, a watertight housing can be hosed down by maintenance personnel if the need arises. Heaters, fans and thermostats are available as standard equipment to be located in such housings to keep the lens from freezing or from getting fogged up in winter or overheating in summer.

### Communication Between Camera and Control Room or Emergency Message Board

System communication between the camera and the computer system is via ethernet for initial system setup. Once the system setup is complete, there are several options available for the camera to output the operational conditions.

First, the camera's configurable onboard input/output points can be activated to turn on an external warning system to alert drivers to the hazardous on the road (this is the default design of the system).

Second, the camera's ethernet connection and/or its onboard serial port can output the inspection results as string data in the form of a number (% density of fog) or as a text string (“Dense Fog”, “Very Dense Fog; Reduce Speed to 15 mph”) based on the level of fog detected.

The live images captured by the camera and its digital inspection data can be transmitted to the control room computer by well-established methods such as

Powerful Ethernet wireless radios
Optic fiber network
Hardwire Ethernet cable, if the distance between the camera and the control room is les than 300 feet.

### Network Capabilities:

Since the system can be configured to output its results via serial text (example text output “Current fog level is 75%” or simply “75%”), it is inherently flexible.
Any system on the network can utilize any standard serial communications program (such as Hyper-terminal which is included with any Windows PC) to display the data from the camera.
Once the camera data has been sent out to the network, it can be displayed on any PC which accesses the camera's IP address.
Since the camera is based on ethernet communications, it will be connected to the network via a secured router with a built-in firewall.
The Intelligent Transportation experts from each local area will review the technology to determine the best means to match the functionality to their system.

What is claimed is:

1. A method for detecting, monitoring and reporting low visibility conditions on roadways, highways, freeways, runways, and waterways occurring due to atmospheric conditions such as fog, snow, rain, dust, smoke etc comprising the steps of:
(a) Installing a special vision camera in the zone prone to low visibility conditions at an appropriate location to view a stationery object such as a light placed at a distance from the camera.
(b) Acquiring a digital image of the object in the camera
(c) Calculating a value for the relative intensity of the said light in a frame defining an area of the image corresponding to the light
(d) Comparing the relative intensity value against a tolerance range for the said frame
(e) Generating an alarm state output if the relative light intensity value is outside said tolerance range.
(f) Transmitting the output images and or the said alarm state output data to an emergency messaging station.
(g) Activating accident prevention steps such as displaying a warning message on a message board or closing of gates or relaying messages on TV or radio stations etc

2. The method of the claim 1 wherein the target for the camera to view is any object such as a lampshade or a light post or a plurality of lights placed at a distance. The selection criterion for the said object is that it should exhibit a large variation in the parameter chosen e.g., light intensity or sharpness, or number of lights, etc between the extremes of high and low visibility conditions.

3. The method of the claim 1 above wherein other parameters available within the vision camera technology such as “counting the number of objects”, or “sharpness of the images of the objects” in the image are used against a tolerance range for the frame.

4. The method of the claim 1 above wherein the area of the frame is substantially less than a total area of the image

5. The method of claim 1 wherein a series of digital images are acquired at periodic time intervals and steps (c) through (e) are repeated for each digital image.

6. The method of claim 5 wherein the periodic time intervals are regular and wherein each is less than one second.

7. The method of claim 1 further comprising of generating a display of the digital image and data.

8. The method of claim 7 further comprising of operatively coupling said alarm state output with said display to superimpose an alarm state display over said image in the display.

9. The method of claim 8 further comprising of translating the said alarm state output and display into an emergency message for the signal board(s) and transmitting the said emergency message to other said emergency messaging systems and or the emergency messaging board(s).

10. Apparatus for detecting, monitoring and relaying low visibility conditions due to fog or snow or rain or dust or smoke on roadways and waterways comprising of the following:
A special vision camera positioned to view a target object such as a set of infra red lights installed at a distance for acquiring images.
A computer software operatively coupled with the camera to receive the digital images, said computer programmed to (1) calculate an array of intensity values relative to a baseline intensity value for a plurality of frames, each area of the frame defining a sub-area of the digital image corresponding to one of the lights in the frame (2) compare the relative intensity values against a tolerance range for each frame, and (3) generate an alarm state output for each light intensity value that is outside the tolerance range;
The alarm state output will activate accident prevention steps such as displaying a warning message on a message board or closing of a gate or relaying messages on TV or radio stations etc
